(19) United States
(12) Patent Application Publication
(10) Pub. No.: US 2004/0068528 A1
(43) Pub. Date: Apr. 8, 2004

(54) Systems and methods for calculating quantitative problems

(76) Inventor: Ranel Einar Erickson, Henderson, NV (US)

Correspondence Address: Ranel Einar Erickson, 1028 San Gabriel St., Henderson, NV, 89015, US

(21) Appl. No.: 10/265,014

(22) Filed: Oct. 4, 2002

(51) Int. Cl. G06F 3/00

(52) U.S. Cl. 708/160

(57) ABSTRACT

This invention provides systems and methods for assigning meaning to the quantities in a quantitative problem and then using those meanings to calculate solutions to the quantitative problems. The method provides for a systematic way of entering the meaning of the quantities in a quantitative problem through new types of mathematical expressions involving quantities, units and dimensions. When this method is implemented using computer software, the user can focus on the meaning of the quantitative problem and have the software manipulate the details of related information. Additional tools needed to find these solutions are proposed through a database containing units, dimensions and relationships between the dimensions.

### BACKGROUND OF THE INVENTION

1. The Field of the Invention

The invention relates generally to the field of modeling by mathematical expressions and more specifically to systems and methods that assign meaning to mathematical expressions of quantities, units and dimensions and thereby calculate solutions to quantitative problems.

2. The Prior State of the Art

Many textbooks and software systems refer to the processes of using units (or dimensions) as a way to verify equations and calculate unit conversions during the formulation and solutions of quantitative problems. These processes are referred to as “dimensional analysis”, “factoring units”, “units analysis”, etc. Unfortunately, ambiguity and confusion arises in the absence of precise definitions and systematic methods that formally assign meaning to quantities in quantitative problems. For example, does “3=1”? Do “3 feet=1 yard”? Do “3 feet of board=1 yard of yarn”? Can we add 2 feet and 3 pounds? Can we add 4 apples and 5 oranges? What do we mean when we define a variable by an equation such as “x=length”?

This ambiguity also leads to conflicting presentations of some elementary concepts taught in mathematics. For example, consider the definition of “ratio” from two typical high school textbooks. On page 190 of the textbook Algebra—Concepts and Applications published by Glencoe/McGraw Hill the authors state that “a rate is a ratio of two measurements having different units of measure.” But, on page 109 of the text book Algebra 1—An Integrated Approach published by Heath/Houghton Mifflin the authors state that “a ratio compares two quantities measured in the same units”. The use of these examples should not be interpreted negatively on these excellent authors, in fact, the current inventor portrayed this typical ambiguity in the patent “Method of Teaching the Formulation of Mathematical Word Problems” (U.S. Pat. No. 5,902,114). Such issues occur because prior art does not carefully define and combine the concepts of units and dimensions into precise meanings associated with quantities in quantitative problems. As an illustration, after the ratio definition on page 109, the Heath textbook gives the following illustration: “win-loss ration=games won/games lost=10 games/6 games=5/3”. Notice how this typical example illustrates the widely accepted vague mixing of quantities and information about those quantities. What is the precise mathematical meaning of these expressions and equalities?

On page 190, the Glencoe textbook defines “dimensional analysis” as “the process of carrying units throughout the computation.” Prior art refers to this process as “factoring analysis”, “units analysis”, etc. But, this widely used practice (especially in the physical sciences) of canceling units is still implemented in a vague manner primarily as labels on the quantities. In other textbooks, especially in the physical sciences, the phrase “dimensional analysis” refers to a completely different process in which the quantities are replaced by base dimension symbols (not the same as “units”) and then algebraically simplified to reduce the number of independent dimensions or verify the validity of relationships. Some of these authors have used brackets to surround dimensional information associated with the quantities, using expressions such as “F [ML/S²]” to indicate that the quantity “force” has a dimensional expression of mass times length divided by seconds squared. The bracketed expression is used as a parenthetical label indicating that the dimension expression can replace the F in a formula such as “F=ma” to verify and manipulate dimensional structure. Other authors, such as Eliezer Naddor have used symbols such as “$” and “Q” to represent cost and quantity dimensions (“Dimensions in Operations Research”, Operations Research, 14:508-514).

The formal notational structure proposed by National Institute of Standards and Technology (NIST) in the Guide for the Use of the International System of Units (SI) falls short of being comprehensive as it suggests the following use of notation for expressing the values of quantities:

“the value of quantity A can be written as A={A}[A], where {A} is the numerical value of A when the value of A is expressed in the unit [A]. The numerical value can therefore be written as {A}=A/[A], which is a convenient form for use in figures and tables. Thus to eliminate the possibility of misunderstanding, an axis of a graph or the heading of a column of a table can be labeled “t/° C.” instead of “t (° C.)” or “Temperature (° C.)”. Similarly, an axis or column heading can be labeled “E/(V/m)” instead of “E(V/m)” or “Electric field strength (V/m)” (Section 7.1 of the Guide)

This notation only combines the numeric value of a quantity to the symbol and unit; it does not involve the dimension. In fact, any attaching or mixing of information (including dimension information) with units is explicitly stated as unacceptable (Section 7.4 and 7.5 of the Guide), most likely because they found no prior art that provided a consistent method of doing this.

In software applications, unit labels are often used in specific computational contexts. For example, units are used in prior art to determine unit conversions. More specifically, graphical design software applications (such as AutoCad and TurboCAD) provide methods to input length units associated with specific objects and allow the user to apply unit conversions over a collection of objects. Such software generally uses the term “dimension” to refer to the “length” dimension of various linear measurements on a two or three-dimensional diagram. Project management software applications (such as Microsoft Project and Primevera) and some of the graphical design software applications provides methods to access databases of cost and time information to determine total costs and time constraints of collections of objects and events. Mathematics solving, optimizing, and graphing software (such as LiveMath, MathCAD, Mathematica, MATLAB and OptiMax) employ methods of tracking units to verify the validity of multiplying quantities. Geographical information systems and other mapping software support different unit scales. Modeling and simulation software applications (such as SansGUI, SimCAD and Simulink) also provide modules for unit conversions. Specialized calculators (such as Measure Master Classic, NautiCalc Plus, ProjectCalc and Real Estate Master) allow the user to enter specific types of related units (even using special keys) and prompt the user with unit labels during the inputting of numeric information into preset formulas (again accessible by special keys).

In all these examples of prior art, the user is still required to enter the mathematical expressions in the same traditional way of entering quantities, operators, and mathematical functions. The novel idea of entering the meaning (using a formally defined combination of units and dimensions) associated with the quantities and then having the system determine operators and mathematical functions for the model does not exist in prior art.

Most books devoted specifically to methods of solving quantitative problems devote themselves to “types” of problems (rate problems, percent problems, volume problems, unit conversion problems, etc.). Even the recent patent “System and methods for searching for and delivering solutions to specific problems and problem types” (U.S. Pat. No. 6,413,100) finds solutions to word problems using this traditional approach. Unfortunately, these traditional approaches remain ambiguous when dealing with meaning.

In summary, there is a need for a method that allows the meaning of the quantities in a quantitative problem to control the modeling process. And as a consequence there is a need for a new kind of computer-implemented system that allows the user to input the meaning of the problem and then have the system formulate the model and calculate solutions. There is a need to allow the students to focus on critical thinking involving the meaning rather than getting overwhelmed by the mechanical operations and solution process that computers can easily provide. There is a need for current educational approaches to provide a comprehensive framework to formulate mathematics and science problems, so that students will not become unduly frustrated with their ability to understand mathematics and science. And there is a need for a centralized depository of the meaning that defines commonly used dimensions from which this new generation of software can draw relationships from when formulating quantitative problems.

### BRIEF SUMMARY OF THE INVENTION

The foregoing problems found in the prior art have been successfully overcome by the present invention, which is directed to systems and methods used to formulate and solve quantitative problems, particularly in math and science. The systems and methods of this invention formally attach meaning to quantities of a quantitative problem in a systematic and consistent way. This results in computer systems that solve quantitative problems based on the meaning.

In the preferred embodiment, this invention attaches meaning by generalizing the concept of a dimension D to a property function of a thing and qualifies a unit u with the dimension that it measures using the symbolic notation “[u˜D]”. This qualified unit is then attached to the quantity q resulting in a unified quantity having the symbolic notation “q [u˜D]”. By breaking the recommended unacceptability of attaching information to units, this significantly extends the national standard (NIST) notation where u corresponds to [A], q corresponds to A, and D is attached information that qualifies the unit.

The qualified unit [u˜D] is not just a label (for quantities, tables, and graphs) as done in prior art, but the open bracket “[”, close bracket “]” and tilde “˜” (read “of”) are mathematical operators; and the unit u, the dimension D, and the qualified unit [u˜D] become symbols that can participate in algebraic manipulations along with the quantities associated with them. This novel approach goes beyond the loosely defined “factoring” or “substitution” processes used in prior art where the units participate in simple cancellation processes only.

These systems and methods captures the complete meaning as apposed to notation of prior art as illustrated in the following unified mathematics notations:

π[m˜circumference]/[m˜diameter]

c ([m˜distance in vacuum]/[s˜time])

t [° C.˜Temperature]

E [V/m˜Electric field strength]

instead of the corresponding NIST notations:

π (dimensionless)

c/(m/s)

t/° C.

E/(V/m)

Indeed, this novel concept of unified quantities allow us to clearly define the meaning of functional relationships. Consider, for example, a simple annual interest calculation. The prior art employs the usual (ambiguous) presentation approach: “I=P*r*t, where I is the interest, P is the principle, r is the rate, and t is the time.” Instead, the methods of this invention construct a unified relationship of unified quantities as follows: “I [dol˜interest]=P [dol˜principle]*r ([dol˜interest]/([dol˜principle]*[yr˜time]))*t [yr˜time]”. Furthermore, this invention clearly defines the meaning of a given quantity; for example, in the above unified relationship, the rate is clearly defined as an annual interest rate (not a monthly rate, etc.). It is known in prior art that units determine the constants that appear in relationships, and so unified relationships with their particular constants become self documenting.

To illustrate how the brackets represent not just words but symbols that the systems and methods of this invention manipulate algebraically, consider substituting “12*month” for “yr” in the unified quantity “t [yr˜time]” the methods of the invention provide a systematic way to algebraically “pull” the constant 12 out of the bracket operator to the front of the unified term resulting in “t [yr˜time]=t [12*month˜time]=(12*t) [yr˜time]” which yields: “I [dol˜interest]=12*P [dol˜principle]*r ([dol˜interest]/([dol˜principle]*[yr˜time]))*t [month˜time]”.

The systems and methods of the present invention introduce unified mathematics rules such as the addition rule: “q₁ [u˜D₁]+q₂ [u˜D₂]=(q₁+q₂) [u˜(D₁+D₂)]”. Furthermore, the systems and methods of the present invention introduce on a new unit, designated “ins” for “instance” in the preferred embodiment, with a corresponding dimension of “occurrence”. This novel approach resolves the dilemma of adding apples and oranges, since in the addition rule the unit “ins” would be the common unit in the expression: “10[ins˜App]+25[ins˜Ora]=(10+25) [ins˜(App+Ora)]”, where, for example, the dimension “App” abbreviates the dimension “occurrences of apples” and we read the phrase “ins˜App” as “instances of occurrences of apples” or for brevity (but not ambiguity), “instances of apples”.

In the preferred embodiment, the invention proposes an extension of the international system of units (SI) by adding two base units, dollar (dol) to measure monetary value of a thing as well as the new instance (ins) unit to measure the dimension “occurrence” of a thing. These new base units allow the systems and methods of this invention to not only model and solve physical science problems but also business and statistics problems.

A computer system of this invention allows the user to enter in the meaning of the quantities in a given quantitative problem using precise and unambiguous unit and dimension notation. The system can then use these unified mathematics methods to find solutions to the quantitative problem from the meaning entered.

### BRIEF DESCRIPTION OF THE SEVERAL VIEWS OF THE DRAWINGS

In order that the manner in which the above recited advantages and objects of the invention are obtained, a more particular description of the invention will be rendered by reference to specific embodiments thereof that are illustrated in the appended drawings. Understanding that these drawings depict only typical embodiments of the invention and are not to be considered to be limiting of its scope, the invention will be described and explained with additional specificity and detail through the use of the accompanying drawings in which:

FIG. 1 is a structure diagram of a database containing units, dimensions and relationships.

FIG. 2 is a sample computer system entry screen illustrating the use of unit expressions.

FIG. 3 is a table of mathematical operations between quantities, units and dimensions.

### DETAILED DESCRIPTION OF THE INVENTION

The following invention is described by using a specific example of a quantitative problem to describe a preferred embodiment of the systems and methods of the present invention. Using the diagrams and the specific example in this manner to present the invention should not be construed as limiting of its scope. The present invention contemplates systems that use any algebraic combination of quantity, units and dimensions and methods for formulating all quantitative problems involving units.

Embodiments of the present invention may comprise a general-purpose computer. Such a general-purpose computer may have any number of basic configurations. For example, such a general purpose computer may comprise any or all of a central processing unit, one or more specialized processors, system memory, mass storage such as a magnetic disk, an optical disk, or other storage device, an input means such as a calculator keypad, keyboard and/or mouse, a display device, and printer or other output device. An apparatus implementing the methods of the present invention can also comprise a special purpose computer, calculator or other hardware systems and all should be included within its scope.

Embodiments within the scope of the present invention also include computer readable media having executable instructions. Such computer readable media can be any available media that can be accessed by a general purpose or special purpose computer via the Internet, networks, and attached computer readable media. By way of example, and not limitation, such computer readable media can comprise RAM, ROM, EPROM, CD ROM and other optical disk storage, magnetic storage devices, or any other medium which can be use to store the desired executable instructions. Combinations of the above should also be included within the scope of computer readable media.

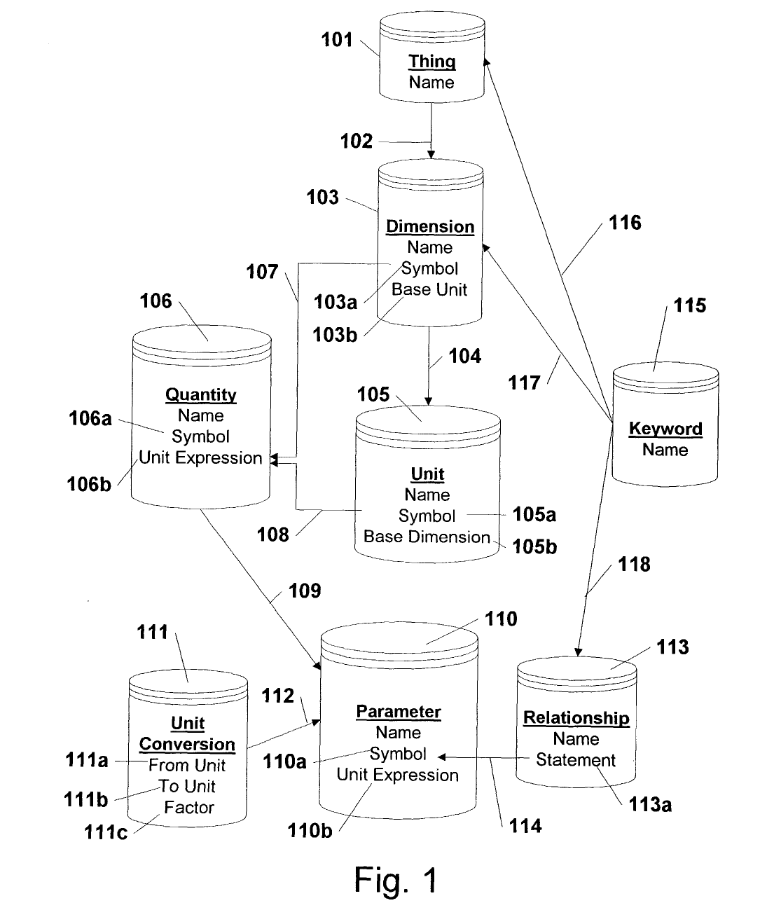

The systems of the present invention comprise computer readable media that enable the characterization of the meaning of quantities in quantitative problems. In the preferred embodiment, computer readable media comprises electronic database tables consisting of collections of records. FIG. 1 represents the relationship between these collection of records where each record image contains its underlined title, name and selected fields. Thus in FIG. 1 each Thing record has a multiplicity of links 102 to a multiplicity of Dimension records 103. Each of the Dimension records 103 has a multiplicity of links 104 to a multiplicity of Unit records 105. The Base Unit field 103b of Dimension record 103 identifies a specific default unit in the Unit records 105 associated with Dimension record 103. Similarly, the Base Dimension field 105b of a Unit record 105 identifies a specific default dimension in the Dimension records 103 associated with Unit record 105.

Each Quantity record 106 contains a Unit Expression field 106b consisting of a mathematical expression of qualified units built from a multiplicity of links 107 from the Symbol field 103a of a multiplicity of Dimension records 103 and from a multiplicity of links 108 from the Symbol field 105a of a multiplicity of Unit records 105.

Each Quantity record 106 has a multiplicity of links 109 to a multiplicity of Parameter records 110 into which the Symbol field 106a of the Quantity record 106 can be substituted into the Symbol field 110a of the Parameter record 110. The possibility of such a substitution is determined by compatibility of the Unit Expression field 106b of the Quantity record 106 and the Unit Expression field 110b of the Parameter record 110. In order to be compatible, the corresponding unit expressions must be identical after unit conversions provided by a multiplicity of Unit Conversion records 111 linked by link 112 to the Parameter records 110. More specifically, such a unit conversion is applicable if a unit in the Unit Expression field 106b of the Quantity record 106 is the same as that in the From Unit field 111a of a Unit Conversion record 111 that has a To Unit field 111b that contains the same unit as a unit in the Unit Expression field 110b of the Parameter record 110. If there is a match, then the Factor field 111c of the Unit Conversion record 111 multiplies the Symbol field 106a to obtain the Symbol field 110a.

Each Relationship record 113 has a multiplicity of links 114 to a multiplicity of Parameter records 110. More specifically, the Statement field 113a of the Relationship record 113 contains a mathematical expression of parameters each of which corresponds to a Symbol field 110a in a Parameter record 110.

Each Keyword record 115 can have a multiplicity of links 116 to a multiplicity of Thing records 101, can have a multiplicity of links 117 to a multiplicity of Dimension records 103 and can have a multiplicity of links 118 to a multiplicity of Relationship records 113. This provides an index of common words that can be used by the general-purpose computer to monitor the information entered by the user and provide lists of related things, dimensions, and relationships associated with the meaning of such input information.

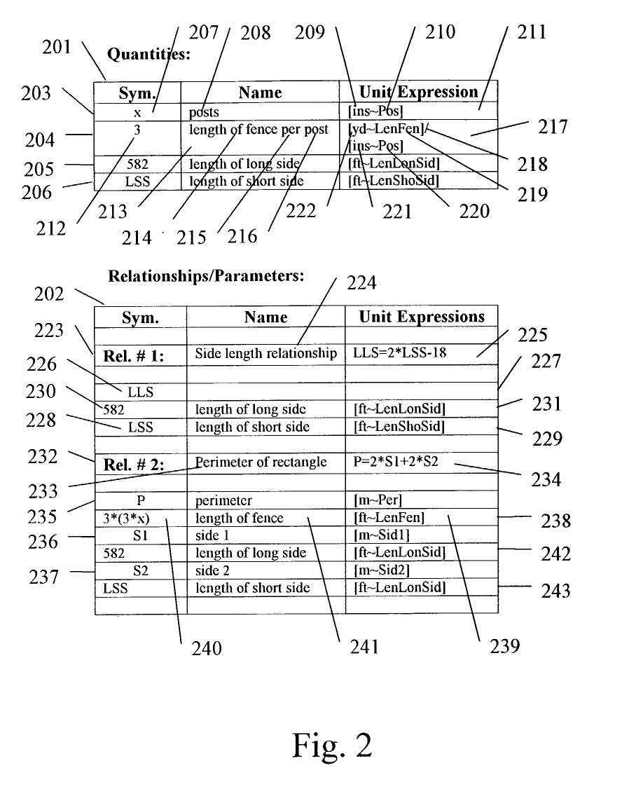

The computer-implemented method of the present invention comprises a sequence of steps that a user takes to enter the meaning of quantities into a general-purpose computer in order to formulate and solve a mathematical model. In the preferred embodiment, computer software displays an input screen depicted in FIG. 2. This input screen uses as an illustration the following quantitative problem:

“A family wants to enclose their rectangular property with a chain link fence that requires iron posts every 3 yards. One side of the property has a length that is 18 less than twice the length of the other side. How many fence posts should they order if the longer side is 582 feet.”

The input screen in FIG. 2 has two entry tables, the Quantities table 201 and the Relationships/Parameters table 202. The Quantities table 201 allows the user to enter information into each of the rows 203, 204, 205, and 206. When entering information into row 203, the user enters a variable symbol “x” in field 207 and its rough meaning “posts” in field 208. The software then helps the user create a more precise notation beginning with a unit expression template in field 211 with the default unit “ins” (representing “instance”) in the unit position 209 and a dimension abbreviation “Pos” in the dimension position 210 of the unit expression 211 in row 203. The abbreviation scheme used in this preferred embodiment takes the first three characters of each word and concatenates them using proper caps. In this case “Pos” abbreviates the one word “Posts”. The system verifies that different quantities have different unit expressions. In the case of identical abbreviations for different names, the full names are used as the abbreviation. The user can edit the unit expression 211 if needed, but it this case, the default unit expression provides a clear unambiguous meaning of the variable “x” entered in field 207.

In this case, the unit expression 211 is the qualified unit “[ins˜Pos]”, a symbolic entity derived from the combination of the unit “ins” and the dimension “Pos”. In general, the user can place in field 211 an algebraic expression of qualified units “[u˜D]” where “u” represents the unit and “D” represents the dimension. The combination of the symbol expression “q” and the unit expression “[u˜D]” results in another symbolic entity, the unified quantity “q [u˜D]”. In this case, row 203, the implied unified quantity is “x [ins˜Pos]”. In row 204, the implied unified quantity is “3[yd˜LenFen]/[ins˜Pos]” where the unit expression is the algebraic expression obtained by taking the quotient of the qualified units “[yd˜LenFen]” and “[ins˜Pos]”. Furthermore, a quantity in a unified quantity can itself be an algebraic expression of quantities as illustrated by the implied unified quantity “3*(3*x) [ft˜LenFen]” in row 238.

The steps of entering quantities and corresponding meanings repeat for each quantity (both numeric and symbolic). For row 204, a numeric value of “3” is placed in field 212 with a corresponding rough meaning of “length of fence per post”. The system parses this phrase into individual words and uses the words to find a multiplicity of related Thing records 101, a multiplicity of related Dimension records 115, and a multiplicity of related Keyword records 115 to assist the user with default information provide by conventional means such as autotyping and dropdown boxes.

The “per” word 215 has operational significance. It invokes a ratio of qualified units designated by the forward slash 218 in the unit expression 217. In the denominator of this quotient the system uses the “post” word 216 in field 213 to provide the default qualified unit made up of the default “ins” unit 221 and the “Pos” dimension 220. In the numerator of this quotient FIG. 2 has “yd” in unit position 222 and the “LenFen” dimension in dimension position 219. Initially, the default qualified unit in the numerator of the unit expression 217 was “[m˜LenFen]” where “m” symbolizes the default unit “meters”. The word “length” in field 213 would have found the dimension “length” in the multiplicity of Dimension records 103. The Base unit 103b associated with this dimension would have yielded the international standard “m” for meters. The user would have highlighted the “m” in the unit position 222 and replaced the “m” with “yd”.

Again, the user can edit the unit expression as much as needed. In this illustration, changing the “m” to “yd” is sufficient and this completes the step of entering row 204. Rows 205 and 206 would be entered in the same way where the user would replace the default “m” in the unit expressions of those rows with “ft”.

The next sequence of steps involves entering relationships and their parameters into the Relationships/Parameters table 202. In this illustration, the user begins by translating and entering the quantitative problem phrase “18 less than twice the length” into the first relationship 223 with its name 224 and statement 225. The parameter symbols used in the statement 225 are parsed and listed in rows below the statement: “LLS” parameter symbol 226 in row 227 and “LSS” parameter symbol 228 in row 229. Each of these rows has corresponding rows underneath them. Since the “LLS” parameter symbol 226 has not been previously entered, the user now takes the steps to provide this parameter with meaning in row 231 corresponding to row 227. Since the quantitative problem gives the length of the long side as 580, the user simply drags row 205 down to row 231 thus automatically providing all the meaning of the “LLS” parameter symbol 226. Since the “LSS” parameter symbol 228 has already been defined in row 206, the system automatically fills in the rest of row 229. The meaning of each of the parameters appearing in the first relationship has now been clearly defined.

The next set of steps defines the second relationship 232 beginning with the step of entering information into the name field 233. When entering information into the name field, the system searches the database Relationship records 113 to find related relationships. In the preferred embodiment, the Relationship records 113 contain many useful equations and other forms of relationships from various disciplines including algebra, geometry, physics, chemistry, economics, finance, accounting, statistics, etc. In this case, the words entered in the second relationship name 233 involves “perimeter” which invokes the meaning of that word, namely, a formula based on a geometric shape, and in this case the geometric shape is the thing “rectangle”. The system could have used either one of these words to find a “Perimeter of rectangle” record among the multiplicity of Relationship records 113. On finding such a record, the system automatically enters statement 234 and all of the information associated with parameters “P” in row 235, “S1” in row 236, and “S2” in row 237.

Now the only rows left for the user to put information into are rows 238, 242, and 243 corresponding to the parameter rows 235, 236, and 237, respectively. In row 238, the user can chose to first enter the unit expression 239. On entering “[ft˜LenFen]” the system can detect the previous use of that dimension “LenFen” in field 217 of the Quantities table 201.

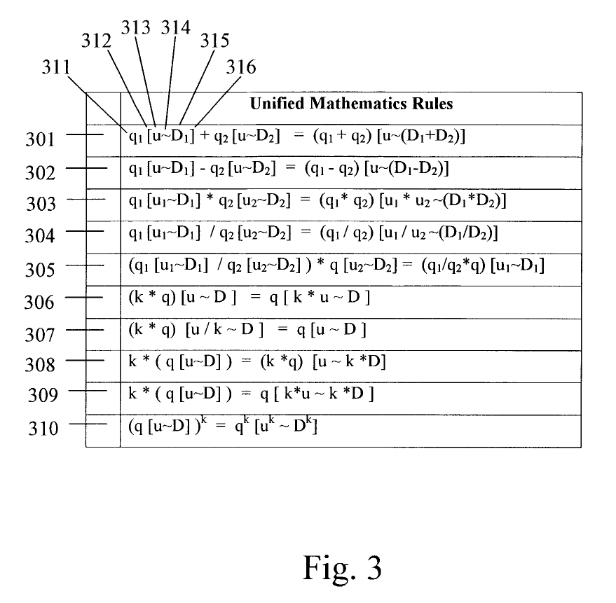

At this point the system can invoke the unified mathematics rules 301-310 listed in FIG. 3. These rules use the general form of the unified quantity symbol q [u˜D] created by combining the quantity symbol q with the unit symbol u and dimension symbol D using operators “[”, “]” and “˜”. More specifically, rule 301 proscribes how to add two unified quantities; and in addition to standard mathematical operators such as the plus operator “+”, it uses a tilde “˜” operator 314 to combine the unit “u” symbol 313 to the dimension “D₁” symbol 315, and then it uses the open bracket “[” operator 312 to combine this combined unit dimension entity to the quantity “q₁” symbol 311. The closed bracket “]” operator 316 is used in conjunction with the open bracket “[” operator 312 to delineate the qualified unit [u˜D₁].

Similarly, rule 302 proscribes how to subtract two unified quantities, rule 303 proscribes how to multiply two unified quantities, rule 304 proscribes how to divide two unified quantities and rule 305 proscribes how to cancel qualified units when multiplying two unified quantities. Rules 306, 307, 308, 309, and 310 proscribe how a constant k can be algebraically manipulated in a unified quantity.

These rules resolve the ambiguous problems found in prior art. For example, with the novel concept of a new unit designated in field 211 for this preferred embodiment as “ins” representing the unit “instances” of the dimension “occurrence” of the thing “post”, we can understand how to require that the units be the same when adding different things. It is the unit “ins”, not the qualified unit [ins˜Pos] in 211 that would need to be the same. (In the classic example of adding apples and oranges, we would have 3 [ins˜App]+4 [ins˜Ora]=7 [ins˜(App+Ora)] where the plus symbol “+” between the dimensions is interpreted as a union of things or equivalently the sum of the property functions associated with those dimensions.)

When applying these rules to this particular example quantitative problem, in order to isolate dimension “LenFen” in field 217, the system searches for and finds in field 211 a quantity with “Pos” dimension 210 matching the “Pos” dimension 220 in the denominator of the unit expression in field 217. Hence the system can use unified mathematics rule 304 of FIG. 3 and multiply these two numbers and cancel out the matching qualified units “[ins˜Pos]” yielding the unified quantity “(3*x)[yd˜LenFen]”. The system can now substitute “3*ft” for “yd” to get “(3*x)[3*ft˜LenFen]” and then use the unified mathematics rule 306 to obtain the unified quantity “3*(3*x)[ft˜LenFen]”. Notice that the resulting unit expression of this unified quantity is now identical to the unit expression 239, hence the system places the quantity expression 3*(3*x) into the symbol field 240 and places the rough meaning “length of fence” from row 204 of the “LenFen” dimension 219 into the name field 241.

The remaining steps illustrate the method's strategy of making sure that each quantity and parameter has a clearly defined meaning assigned to it. In this illustration, to finish the modeling process, the user still needs to assign meaning to the “S1” parameter in row 236 and the “S2” parameter in row 237. To this end, the user simply drags row 205 down to row 242 and row 206 down to row 243.

After substituting the associated values in the two relationships, these steps have resulted in two equations in two variables: “582=2*LSS−18” and “3*(3*x)=2*582+2*LSS”. In the preferred embodiment, the system will display these equations and demonstrate a solution using any of the many methods available from prior art. In this case the solution results in x=196 and LSS=300.

The units, dimensions, and relationships of the quantities in a quantitative problem can be stored together in a standard file (such as an XML file) that allows the transfer of the One application of this invention involves a publisher who provides a central depository of units, dimensions, and relationships accessed via the Internet (or distributed on CD-ROMs). This information resource would be accessible to a unified mathematics software application distributed with each of their published textbooks either over the Internet or by CD-ROM. Applicable textbooks would range over various disciplines including algebra, physics, chemistry, finite mathematics, finance, economics, management science, social sciences, and statistics.

I claim:

1. A method of attaching meaning to a quantity in a quantitative problem comprising:
identifying a property of a thing implied in the quantitative problem that the quantity represents;
assigning to the quantity a dimension symbol that represents the identified property;
assigning to each quantity a unit symbol that determines the scale used to measure the assigned dimension;
combining the unit symbol and the dimension symbol into a unit-dimension symbol using a mathematical operator; and
combining the quantity with the unit-dimension symbol using a mathematical operator.

2. The method of attaching meaning in claim 1 further comprising:
assigning to an algebraic expression of a plurality of quantities in the quantitative problem a unit expression consisting of the same algebraic expression of the corresponding unit-dimension symbols.

3. The method of attaching meaning in claim 2 further comprising:
verifying that each different quantity in the quantitative problem has a unique unit expression.

4. The method of attaching meaning in claim 3 further comprising:
associating with each algebraic expression of unit-dimension symbols an algebraic expression of corresponding quantities with a meaning inherited from the unit-dimension symbols used in the algebraic expression.

5. The method of attaching meaning in claim 1 further comprising:
storing each combined quantity and unit-dimension symbol together with the text of the quantitative problem in a standardized electronic file that allows the interchangeability of the quantitative problem information with different general purpose computer systems that adhere to the standard.

6. The method of attaching meaning in claim 5 further comprising:
storing relationships between dimensions in the quantitative problem in the standardized electronic file.

7. A system of calculating a solution to a quantitative problem comprising:
means of associating unit expressions to quantity expressions in the quantitative problem;
means of combining previously defined quantity expressions into more complex quantity expressions based on the unit expressions associated with the quantity expressions;
means of selecting from a multiplicity of dimension definitions those with mathematical relationships that contain parameters having unit expressions compatible to the unit expressions of quantity expressions in the quantitative problem; and
means of using unit expressions to determine substitutions of quantity expressions and parameters of other mathematical relationships into the parameters of a selected mathematical relationship.

8. The system of calculating a solution in claim 7 further comprising:
means of displaying the logical steps of combining and substituting quantities to obtain a mathematical model of the quantitative problem.

9. A computer readable media having computer-executable instructions comprising:
means of storing a plurality of units from at least one existing unit system;
means of storing for each of these units a default dimension based on a typical property of a typical thing that the unit measures;
means of storing a new unit that measures the dimension “occurrences” of a thing;
means of using this new unit to satisfy a requirement of algebraically adding only those quantities with the same units.

10. An electronic apparatus that calculates solutions to quantitative problems comprising:
means for entering numeric quantities of the quantitative problem;
means for entering alphabetic symbols associated with variable quantities in the quantitative problem;
means for entering the meaning of the numeric and symbolic quantities;
means for determining a unit expression associated with each quantity based on the meaning entered;
means for calculating a new unit expression for an algebraic combination of quantity expressions based on the same algebraic combination of the unit expressions associated with the quantity expressions; and
means for calculating a new quantity expression for an algebraic combination of unit expressions based on the same algebraic combination of the quantity expressions associated with the unit expressions.

11. The electronic apparatus in claim 10 further comprising:
means for selecting from a multiplicity of dimension definitions those dimension definitions having mathematical relationships that contain quantity parameters related to the quantitative problem.

12. The electronic apparatus in claim 11 further comprising:
means for substituting previous defined quantities and parameters into the parameters of selected mathematical relationships based on the compatibility of the unit expressions of those quantities being substituted with those unit expressions of the parameters into which they are being substituted; and
means for displaying the resulting mathematical equations.

13. The electronic apparatus in claim 12 further comprising:
means of checking the consistency of the dimension expression associated with the quantities substituted with the dimension expression of the parameter into which the quantities are being substituted.

14. The electronic apparatus in claim 13 further comprising:
means of converting a unit in a unit expression associated with a quantity being substituted into a unit in the unit expression associated with the parameter into which the quantities are substituted.

15. The electronic apparatus in claim 14 further comprising:
means of displaying the logical steps of combining and substituting quantities based on unit expressions.

16. The electronic apparatus in claim 15 further comprising:
means of displaying the logical steps of algebraically or numerically solving the mathematical model of the quantitative problem.

17. A computer implemented method for the assignment of meaning to a quantity entered into a computer software application comprising:
means of entering the quantity;
means of entering a unit;
means of entering a dimension;
means of combining the unit and dimension into a new symbolic entity; and
means of associating the new symbolic entity with the quantity.

18. The computer implemented method for the assignment of meaning of claim 17 further comprising:
means of storing a plurality of units;
means of storing a plurality of unit conversion factors that relate pairs of the stored units; and
means of selecting from this plurality of units, specific units that relate to the entered unit using a unit conversion factor.

19. The computer implemented method for the assignment of meaning of claim 18 further comprising:
means of storing a plurality of relationships; and
means of selecting from this plurality of relationships, specific relationships that involve the entered dimension.

20. The computer implemented method for the assignment of meaning of claim 19 further comprising:
means of storing a plurality of dimensions; and
means of selecting from this plurality of dimensions, specific dimensions that relate to the entered dimension by at least one relationship in the plurality of stored relationships.

21. The computer implemented method for the assignment of meaning of claim 20 further comprising:
means of storing a plurality of keywords;
means of relating each keyword in the plurality of stored keywords to at least one the units in the plurality of stored units, at least one of the dimensions in the plurality of stored dimensions, or at least one of the relationships in plurality of stored relationships.
means of entering a specific keyword;
means of selecting from the plurality of stored units, dimensions, and relationships specific units, dimensions, or relationships that relate to an entered unit or dimension.

22. An electronic system of meanings that can be associated with quantities in a quantitative problem comprising:
a computer readable media containing a plurality of things that represent real objects and events;
a computer readable media that contains for each thing a plurality of dimensions that represent abstract properties of the things;
a computer readable media that contains for each dimension a plurality of units that represent a scale used to measure the dimension;
a computer readable media that contains for each dimension a default unit for each dimension;
a computer readable media that contains a plurality of mathematical relationships between the dimensions based on the default units;
a computer readable media that contains a plurality of conversion factors between units related proportionally; and
a computer readable media containing a plurality of keywords with links to related things, dimensions, and units in the meaning system.
